(19) United States
(12) Patent Application Publication
(10) Pub. No.: US 2015/0017964 A1
(43) Pub. Date: Jan. 15, 2015

(54) Method and System for Downloading Application

(71) Applicant: BIOSPACE CO., LTD., Seoul (KR)

(72) Inventor: Ki Chul Cha, Seoul (KR)

(73) Assignee: BIOSPACE CO., LTD., Seoul (KR)

(21) Appl. No.: 14/173,600

(22) Filed: Feb. 5, 2014

(30) Foreign Application Priority Data
Jul. 10, 2013 (KR) 10-2013-0080778

(51) Int. Cl. H04W 4/00

(52) U.S. Cl. CPC H04W 4/003
USPC 455/418

(57) ABSTRACT

A method for downloading an application includes sensing an outgoing call to a preset connected line identification from a mobile device, sending a message for downloading an application on the mobile device, when the outgoing call is sensed; and downloading the application on the mobile device from an application server, in which the application is stored, in response to a user gesture for the message.

### CROSS REFERENCE TO RELATED APPLICATION

This application claims priority from and the benefit of Korean Patent Application 10-2013-0080778, filed on Jul. 10, 2013, which is hereby incorporated by reference for all purposes as if fully set forth herein.

### BACKGROUND OF THE DISCLOSURE

1. Field of the Disclosure

Exemplary embodiments of the disclosure relate to a method and a system for downloading and installing an application simply.

2. Discussion of the Background

To download an application on a smart phone, 1) a user implements an application for purchasing applications (e.g., Google Play or App Store) and 2) searches an application desired to download. After that, 3) the user selects a desired application from applications displayed on the result of the searching and 4) downloads the selected application in his or her smart phone.

However, the method for downloading an application is cumbersome which implements several steps to download a desired application. Relatively high age users feel difficulty installing an application on their smart phones and that disturbs usage of the application. Such a disadvantage cannot but be a big obstacle from the application provider's perspective who desires to provide the application to as many users as possible and to enhance a penetration rate of the application.

There are attempts to reduce the steps 1), 2) and 3) mentioned above to solve disadvantages. One of the attempts it to provide URL of a corresponding application installation screen so as to skip the prior steps and perform 4) immediately. However, a user inputs the URL to an address window and moves to a screen for installing the corresponding application of the market. In this instance, the user has to input the URL directly one by one character inconveniently. Some users take this inconvenient and it is almost impossible for the user to memorize the URL to download a desired application, after a reasonable period of time. Also, user convenience might deteriorate.

Another one of the conventional attempts provides QR code containing information on the URL to connect to the URL immediately. However, to implement the QR code, a user implements an application for reading the QR code and photographs the QR code to make the information contained by the photograph recognized. In other words, some users may feel difficulty photographing the QR code clearly enough to make the QR code recognized.

### SUMMARY OF THE DISCLOSURE

Exemplary embodiments of the present disclosure provide a method, an apparatus and a system for measuring a location of a user terminal, using a magnetic field sensor provided in a user terminal and information on a map of a magnetic field.

Exemplary embodiments of the present disclosure also provide a method, an apparatus and a system which may use a different sensor distinguished from the magnetic field sensor, while measuring the location of the user terminal using the magnetic field sensor and the information on the map of the magnetic field.

Exemplary embodiments of the present disclosure provide a method and a system for downloading an application which may secure user convenience.

Exemplary embodiments of the present disclosure also a method and a system for downloading an application which may induce a user to download a desired application automatically, using a phone which is already familiar to the user, without inconvenience of inputting URL for downloading the application directly or implementing another application additionally.

Exemplary embodiments of the present disclosure disclose a method for downloading an application including sensing an outgoing call to a preset connected line identification from a mobile device; sending a message for downloading an application on the mobile device, when the outgoing call is sensed; and downloading the application on the mobile device from an application server, in which the application is stored, in response to a user gesture for the message.

The message for downloading the application on the mobile device may be sent right after the outgoing call is sensed, while a call back tome of the connected line identification is sending to the mobile device, while a call is connected to the mobile device or right after the call with the mobile device ends.

The message for downloading the application on the mobile device may be a text message.

The message for downloading the application on the mobile device may include an URL.

The message for downloading the application may include an audio guidance.

The message for downloading the application may be a mobile instant message.

The application server may implement the application on the mobile device, once determining that the application is installed with no need for download.

The method for downloading the application may further include comparing the connected line identification with a plurality of phone numbers; and selecting one or more of the applications based on the connected line identification.

The method for downloading the application may include selecting the one or more applications to download on the mobile device.

The selecting of the applications may select the applications before or after sending the message.

The method for downloading the application may further include determining a type of the mobile device, when the user gesture for the message is sensed, wherein the downloading of the application redirects an access of the mobile device to download a corresponding application to the type of the mobile device.

In another aspect, embodiments of the disclosure disclose a system for downloading an application including a sensing unit for sensing an outgoing call to preset connected line identification from a mobile device; a message sending unit for sending a message to downloading an application on the mobile device, when sensing the outgoing call; a download implementing unit for downloading the application on the mobile device from the application server, in which the application is stored, in response to the user gesture for the message.

In a further aspect, embodiments of the disclosure disclose a system for downloading an application including a service server for asking a message for downloading an application to be send, when an outgoing call to a preset connected line identification is sensed from a mobile device; a message server for sending a message for downloading the application on the mobile device based on the request of the service server; and an application server for storing and maintaining the application and for downloading the application on the mobile device based on the request of the service server, wherein the service server requests the application server to download in response to a user gesture for the message.

According to the embodiments of the disclosure, the method and the system may enable the application automatically downloaded, using a phone call already familiar to a user such that the download of the application may be performed more simply and easily.

It is to be understood that both the foregoing general description and the following detailed description are exemplary and explanatory and are intended to provide further explanation of the disclosed subject matter as claimed.

### BRIEF DESCRIPTION OF THE DRAWINGS

The accompanying drawings, which are included to provide a further understanding of the disclosed subject matter and are incorporated in and constitute a part of this specification, illustrate exemplary embodiments of the disclosed subject matter, and together with the description serve to explain the principles of the disclosed subject matter.

FIG. 1 is a diagram schematically illustrating relations among a mobile device, a service server, message server and an application server;

FIG. 2 is a flow chart illustrating a method of a service for inducing a user to download an application according to exemplary embodiment of the disclosure, using a phone; and

FIG. 3 is a block diagram illustrating a structure of a service server for inducing the user to download an application according to exemplary embodiment of the disclosure, using a phone.

### DETAILED DESCRIPTION OF THE ILLUSTRATED EMBODIMENTS

Exemplary embodiments of the disclosed subject matter are described more fully hereinafter with reference to the accompanying drawings. The disclosed subject matter may, however, be embodied in many different forms and should not be construed as limited to the exemplary embodiments set forth herein. Rather, the exemplary embodiments are provided so that this disclosure is thorough and complete, and will convey the scope of the disclosed subject matter to those skilled in the art. In the drawings, the size and relative sizes of layers and regions may be exaggerated for clarity. Like reference numerals in the drawings denote like elements.

It will be understood that when an element or layer is referred to as being “on”, “connected to”, or “coupled to” another element or layer, it can be directly on, connected, or coupled to the other element or layer or intervening elements or layers may be present. In contrast, when an element is referred to as being “directly on”, “directly connected to”, or “directly coupled to” another element or layer, there are no intervening elements or layers present. As used herein, the term “and/or” includes any and all combinations of one or more of the associated listed items. It may also be understood that for the purposes of this disclosure, “at least one of X, Y, and Z” can be construed as X only, Y only, Z only, or any combination of two or more items X, Y, and Z (e.g., XYZ, XYY, YZ, ZZ).

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another region, layer or section. Thus, a first element, component, region, layer, or section discussed below could be termed a second element, component, region, layer, or section without departing from the teachings of the present disclosure.

The terminology used herein is for the purpose of describing exemplary embodiments only and is not intended to be limiting of the disclosed subject matter. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the disclosed subject matter are described herein with reference to cross-section illustrations that are schematic illustrations of idealized embodiments (and intermediate structures) of the disclosed subject matter. As such, variations from the shapes of the illustrations as a result, for example, of manufacturing techniques and/or tolerances, are to be expected. Thus, exemplary embodiments of the disclosed subject matter should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the disclosed subject matter will be described in detail with reference to the accompanying drawings.

The exemplary embodiments of the present discloser relate to a method and a system for downloading and installing an application more simply.

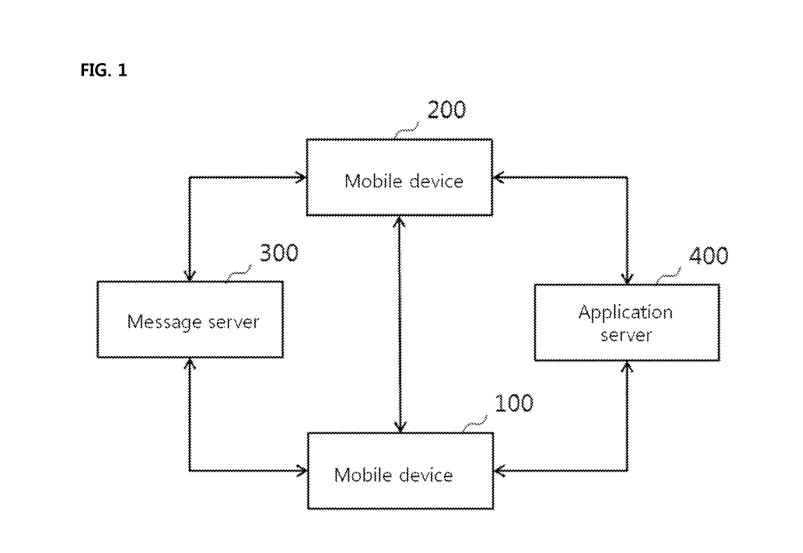

FIG. 1 is a diagram schematically illustrating relations among a mobile device, a service server, message server and an application server. FIG. 1 shows a mobile device 100, a service server 200, a message server 300 and an application server 400. An arrow shown in FIG. 1 means that data can be transmitted among the components via wire/wireless network.

Examples of the mobile device 100 include a smart phone, a tablet, a laptop computer, a digital broadcasting terminal, a portable multimedia player (PMP) and a navigation system. The mobile device 100 can mean all types of terminals capable of installing and implementing an application, with a function of making a call through a cable or internet.

The service server 200 may be employed as a service platform for inducing download of the application, using a phone. In this specifically, the term of “application” may include all of applications mountable on a mobile device. For example, the service server 200 may induce an application on the mobile device 100 and the application is associated with a health care device (e.g., a body composition analyzer, a body fat analyzer, a sphygmomanometer and a body weight scale) or ubiquitous health (U-health) based services.

The message service 300 may transmit a message for inducing an application to the mobile device 100 according to a request of the service server 200. At this time, the message server 300 may be realized as one or more of a short message device (SMS), multi-media message service (MMS), an automatic response system (ARS) and an instant message.

The application server 400 is a database system which stores and keeps an application mountable on the mobile device 100. The application server may mean a market place on on-line where developers and users can freely register and download applications. In this embodiment, the application server 400 may download and install a specific application requested over a phone by the user on the mobile device 100.

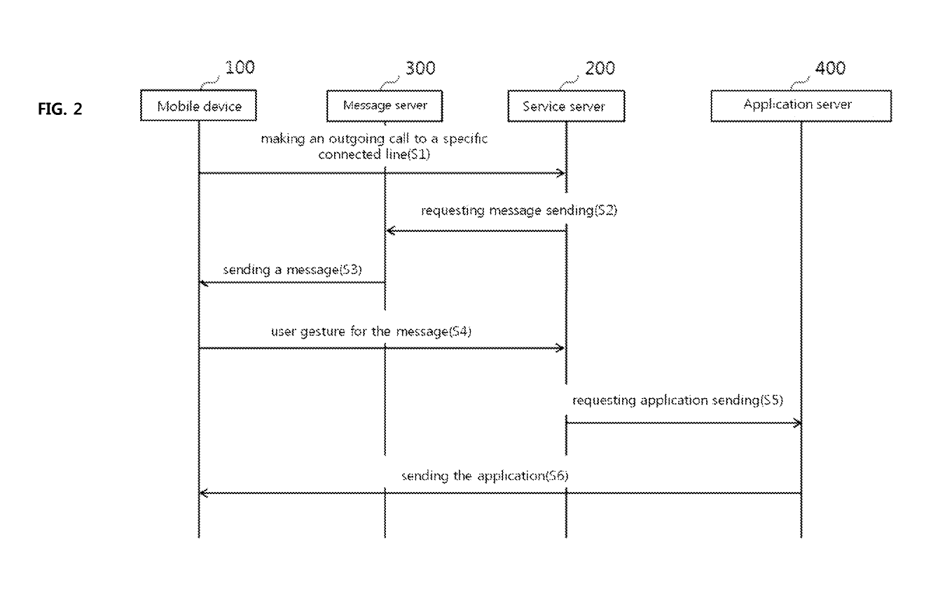

Referring to FIG. 2, an operation of a system for downloading an application according to the exemplary embodiments of the present disclosure will be described.

FIG. 2 is a flow chart illustrating a method of a service for inducing a user to download an application according to exemplary embodiment of the disclosure, using a phone.

First of all, the service server 200 may set a specific phone number with respect to an application registered with the application server 400 and distribute or guide phone numbers preset for applications, respectively, through various media. For example, heat information about the user measured by a heat care device or personal information input by the user may be stored or managed in the service server 200. Also, the service server 200 may match a specific phone number with a health care application for the mobile device to process the user's health information or personal information.

The user attempts to make an outgoing call to a specific connected line identification associated with an application desired to download by the user, using the mobile device 100. Accordingly, the service server 200 may detect the outgoing call for a voice call to the specific connected line identification from the mobile device 100 (S1).

When detecting a calling for the voice call to the specific connected line identification from the mobile device 100, the service server 200 may ask the message server 300 to sent a message for inducing download of the application on the mobile device 100 (S2). For example, the service server 200 checks caller ID and identifies the phone number of the mobile device 100. After that, the service server 200 may transmit a message sending request signal to the message server 300, together with the phone number of the mobile device 100. At this time, the service server 200 may transfer contents of the message desired to send to the mobile device 100 to the message server 300. The contents of the message may contain information on the application matched with the connected line identification from the mobile device 100 (e.g., a title, descriptions, an ARS number and an URL address for downloading the application).

The message server 300 creates a message for inducing the specific application based on the message sending request signal and sends the created message to the mobile device 100 (S3). For example, the message server 300 creates and sends a SMS or MMS containing contents of the message. Alternatively, the message server 300 may create and send a message containing an URL address for downloading the application or the message server 300 may create an ARS message containing contents of the message or a message containing an ARS connected number. Also, the message server 300 may send the contents of the message as a mobile instant message through a messenger platform. In other words, the message server 300 may create various types of messages, using a callback service which makes a callback from the mobile device 100, a message oriented (MO) service which receives a response to a message and an ARS service for connecting an audio guidance.

The message for inducing the downloading of the application may be realized to be sent at a predetermined point where call connection is kept after a call is detected from the mobile device 100 after detecting a call is detected. For example, the message may be sent at one of points right after the call is detected from the mobile device 100, while a ring back tone for the connected line identification is sent, right after a call to the mobile device 100 is connected, while the call connection with the mobile device 100 is kept and right after the call with the mobile device 100.

The user may checks the message received on the mobile device 100 and takes a gesture requesting download of a specific application (e.g., sending a response to the message and selecting a specific menu according to an audio guidance) after that. The service server 200 may recognize a user gesture for the message from the mobile device 100 (S4).

The service server 200 may ask the application server 400 to download the specific application on the mobile device 100 in response to the user gesture for the message (S5). Accordingly, the application server 400 may send the specific application to the mobile device 100 according to the request of the service server 200 (S6).

For example, the service server 200 selects one or more of the applications based on the connected line identification from the mobile device 100 and requests downloading of the corresponding one or more applications. At this time, the service server 200 compares a plurality of phone numbers matched with a plurality of applications, respectively with a connected line identification of the call from the mobile device 100 and it selects the corresponding application to the corresponding connected line identification based on the result of the comparison.

Alternatively, the service server 200 may directly receive a type of the application desired to be downloaded from the user, when several applications are matched with one phone number or an application is not specified. For example, the service server 200 may provide the user with a list of downloadable applications as a phone call or a message. Accordingly, the user may select a type of an application desired to download. A process of selecting the type of the application to download may be performed before the message sensing or after message sending.

In addition, the service server 200 determines the type of the mobile device 100 (e.g., a type of OS), when detecting a user gesture for the message. After that, the service server 200 may redirect an access of the mobile device to download the application corresponding to the type of the mobile device 100. The service server 200 capable of providing the corresponding application to the type of the mobile device may ask the application server 400 to download the corresponding application or classifies types of mobile devices 100 based on the request on the service server 200 and provides an application installable on the mobile device 100.

Meanwhile, when determining that the application selected by the connected line identification from the mobile device 100 or selected by the user directly is installed on the mobile device 100 already, with no necessity of downloading, the application server 400 may control the corresponding application to be implemented on the mobile device 100. At this time, the application server 400 may check the application list provided in the mobile device 100. When the application the user asks for downloading is already installed, the downloading process may not be implemented and the corresponding application may be implemented on the mobile device 200 to make the user check.

Accordingly, the application may be downloaded, using the phone call.

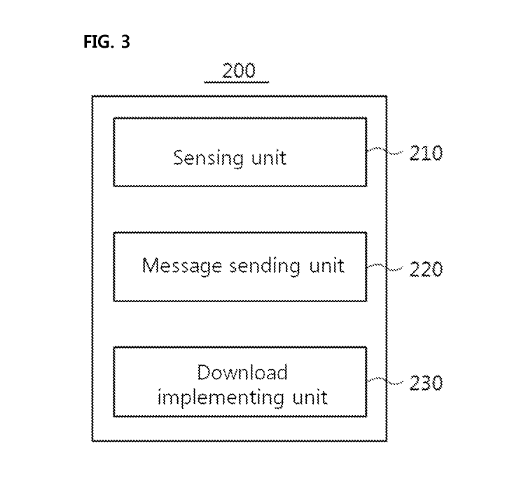

FIG. 3 is a block diagram illustrating a structure of a service server for inducing the user to download an application according to exemplary embodiment of the disclosure, using a phone. A system for downloading an application 200 according to the exemplary embodiments of the disclosure may be realized on the service server shown in FIGS. 1 and 2. The system for downloading the application may include a sensing unit 210, a message sending unit 220 and a download implementing unit 230.

The sensing unit 210 may sense a call to a preset connected line identification from the mobile device. In other words, when the user makes a call to a specific phone number associated with a desired application, the sensing unit 210 provided in the service server containing the corresponding to the phone number may sense call-incoming from the mobile device.

The message sending unit 220 may ask the message server to send a message for inducing an application to the mobile device, when sensing an outgoing call to a specific number from the mobile device. At this time, the message sending unit 220 may send a phone number of the mobile device and contents of the message to the message server, together with a message sending request signal. Especially, the message sending unit 220 may request message sending to the mobile device at one of points of time right after sensing the outgoing call from the mobile device, while a ring back tone for the connected line identification is sending to the mobile device and right after the call with the mobile device is connected, while the call connection with the mobile device is maintained and right after the call with the mobile device ends. The message server creates an SMS or MMS containing the contents of the message, a message containing an URL address for downloading applications, an audio guidance message containing the contents or a message containing an ARS connecting number or a mobile instant message containing contents as a message platform.

The user may made a gesture for requesting download of the specific application (e.g., sending a message reply and selecting a specific menu), after checking the message received on the mobile device. Accordingly, the sensing unit 210 provided in the service server may recognize a user gesture for the message to induce the download of the application.

The download implementing unit 230 may ask the application server to download the specific application on the mobile device in response to the user gesture for the message. For example, the download implementing unit 230 may select one or more of the applications based on the connected line identification from the outgoing call of the mobile device and ask download of the corresponding application. At this time, the download implementing unit 230 compares the plurality of the phone numbers matched with the plurality of the applications with the connected line identified from the outgoing call of the mobile device and selects the corresponding application to the corresponding connected line. Alternatively, the download implementing unit 230 may provide the user with a call or message containing a list of calls or downloadable applications and receive selection of the application type to download input by the user directly, when several applications are matched with one phone number or one application is specified to one phone number. At this time, the selecting of the type of the application to download may be performed before or after sending the message. After that, the application server may download the application selected by the connected line identified from the outgoing call of the mobile device or selected by the user directly on the mobile device.

When sensing the user gesture for the message, the download implementing unit 230 determines the type of the mobile device (e.g., a type of OS) and redirect an access of the mobile device to download an application corresponding to the determined type of the mobile device. The download implementing unit 230 may ask the application server capable of providing the application corresponding to the type of the mobile device to download the corresponding application or the application server may classify the type of the mobile device sensed by the download implementing unit 230 to provide the application downloadable on the mobile device.

When determining that the application selected based on the connected line identified from the outgoing call of the mobile device or the application directly selected by the user is already installed on the mobile device only not to be downloaded, the application server may control the mobile device to implement the corresponding application. The application server may check the list of the applications installed on the mobile device. When the application asked to download by the user is already installed, the downloading is not implemented and the corresponding application may be implemented on the mobile device to enable the user to identify.

The system for downloading the application may include less or more components than the components described in detail, referring to FIGS. 1 and 2. Two or more of the components may be combined and the driving order or the positions of the components may be changed.

The mobile device may include a central processing unit (CPU), a video processor, an audio processor, a memory, an auxiliary memory device, a display, an audio, a communication interface and a user interface. The user may input a specially connected line identification, using touch interface or touch pen and a hard keyboard, and the input connected line identification may be stored in the memory or the auxiliary memory device. Once an outgoing voice call is made to the connected line identification, a call for the voice call is transmitted to the service server through a communication interface. The message for downloading the application transmitted from the message server is displayed on the display of the mobile device. When the user attempts to download the application, the application is downloaded on the mobile device from the application server.

The message server, the service server and the application server may be realized by wide use servers. The wide use may include a processor, a memory, an auxiliary memory device and a communication interface.

According to the embodiments of the disclosure, the download of the desired application may be induced by the calls already familiar to the user such that the application can be downloaded more simply and more easily.

The device mentioned above may be realized by hardware components, software components and/or combination of hardware components and software components. For example, the device and components mentioned in the embodiments may be realized by a processor, a controller, an arithmetic logic unit (ALU), a digital signal processor, a microcomputer, a field programmable gate array (FPGA), a programmable logic unit (PLU), a microprocessor and one or more wide use computers or special purpose computer. The processing device may implement OS or one or more software applications implemented on the OS. In addition, the processing device may access, store, manipulate, process and generate data in response to the software implementation. For make the embodiments understood easily and conveniently, one processing device may be used and it is well-known to those skilled in the art that the processing device includes a plurality of processing elements and/or a plurality of types of processing elements. For example, the processing device may include a plurality of processors or one processor and one controller. Also, a processing configuration (e.g., a parallel processor) may be enabled.

The software may include a computer program, a code, an instruction or one or more of combinations thereof. The software may configurate a processing device to be operated properly or command the processing device collectively. The software and/or data may be embodied to a predetermined type mechanism, a component, a physical device, a virtual equipment, a computer storage media or device or transmitted signal wave permanently or temporarily to be analyzed by the processing device or to provide a command or data to the processing device. The software may be dispersed on a computer system connected in a network and stored or implemented in a dispersed method. The software and data may be stored in one or more computer readable recording media.

The method according to the embodiments may be realized as a program command implementable by various computer means and stored in a computer readable media. The computer readable media include a program command, a data file, and a data structure which are independently provided or combined with each other. The program command recorded in the media may be designed and configured for the embodiments specially or it may be one of commands well-known to those skilled in computer software. Examples of the computer readable recording media include a magnetic media (e.g., a hard disk, a floppy disk and a magnetic tape), an optical media (e.g., CD-ROM and DVD), a magneto-optical media (e.g., a floptical disk), ROM, RAM, a flash memory and other hardware devices configured to store and implement a program command. Examples of the program command include a machine language code made by a compiler and a high-level language code implementable by a computer, using an interpreter. The hardware device may be configured as one or more software modules to implement operations of the embodiments and vice versa.

It will be apparent to those skilled in the art that various modifications and variations can be made in the present disclosure without departing from the spirit or scope of the disclosed subject matter.

Thus, it is intended that the present disclosure cover the modifications and variations of the disclosed subject matter provided they come within the scope of the appended claims and their equivalents.

What is claimed is:

1. A method for downloading an application comprising:
sensing an outgoing call to a preset connected line identification from a mobile device;
sending a message for downloading an application on the mobile device, when the outgoing call is sensed; and
downloading the application on the mobile device from an application server, in which the application is stored, in response to a user gesture for the message.

2. The method for downloading the application according to claim 1, wherein the message for downloading the application on the mobile device is sent right after the outgoing call is sensed, while a call back tome of the connected line identification is sending to the mobile device, while a call is connected to the mobile device or right after the call with the mobile device ends.

3. The method for downloading the application according to claim 1, wherein the message for downloading the application on the mobile device is a text message.

4. The method for downloading the application according to claim 1, wherein the message for downloading the application on the mobile device comprises an URL.

5. The method for downloading the application according to claim 1, wherein the message for downloading the application comprises an audio guidance.

6. The method for downloading the application according to claim 1, wherein the message for downloading the application is a mobile instant message.

7. The method for downloading the application according to claim 1, wherein the application server implements the application on the mobile device, once determining that the application is installed with no need for download.

8. The method for downloading the application according to claim 1, further comprising:
comparing the connected line identification with a plurality of phone numbers; and
selecting one or more of the applications based on the connected line identification.

9. The method for downloading the application according to claim 1, further comprising:
selecting the one or more applications to download on the mobile device.

10. The method for downloading the application according to claim 9, wherein the selecting of the applications selects the applications before or after sending the message.

11. The method for downloading the application according to claim 1, further comprising:
determining a type of the mobile device, when the user gesture for the message is sensed,
wherein the downloading of the application redirects an access of the mobile device to download a corresponding application to the type of the mobile device.

12. A system for downloading an application comprising:
a sensing unit for sensing an outgoing call to preset connected line identification from a mobile device;
a message sending unit for sending a message to downloading an application on the mobile device, when sensing the outgoing call;
a download implementing unit for downloading the application on the mobile device from the application server, in which the application is stored, in response to the user gesture for the message.

13. The system for downloading the application according to claim 12, wherein the message for downloading the application on the mobile device is sent right after the outgoing call is sensed, while a call back tome of the connected line identification is sending to the mobile device, while a call is connected to the mobile device or right after the call with the mobile device ends.

14. The system for downloading the application according to claim 12, wherein the message for downloading the application on the mobile device is a text message.

15. The system for downloading the application according to claim 12, wherein the message for downloading the application on the mobile device comprises an URL.

16. The system for downloading the application according to claim 12, wherein the message for downloading the application comprises an audio guidance.

17. The system for downloading the application according to claim 12, wherein the message for downloading the application is a mobile instant message.

18. The system for downloading the application according to claim 12, wherein the application server implements the application on the mobile device, once determining that the application is installed with no need for download.

19. The system for downloading the application according to claim 12, wherein once sensing the user gesture for the message, the download implementing unit determines a type of the mobile device and redirects an access of the mobile device to download a corresponding application to the type of the mobile.

20. A system for downloading an application comprising:
a service server for asking a message for downloading an application to be send, when an outgoing call to a preset connected line identification is sensed from a mobile device;
a message server for sending a message for downloading the application on the mobile device based on the request of the service server; and
an application server for storing and maintaining the application and for downloading the application on the mobile device based on the request of the service server,
wherein the service server requests the application server to download in response to a user gesture for the message.
